(19) United States
(12) Patent Application Publication
(10) Pub. No.: US 2011/0247794 A1
(43) Pub. Date: Oct. 13, 2011

(54) FLATTENED TUBES FOR USE IN HEAT EXCHANGERS AND OTHER SYSTEMS, AND ASSOCIATED METHODS OF MANUFACTURE AND USE

(76) Inventors: Bradley Arment, Shelbyville, MO (US); Barton L. Arndt, O'Fallon, IL (US); Forrest Nixon, Columbia, IL (US)

(21) Appl. No.: 13/077,621

(22) Filed: Mar. 31, 2011

Related U.S. Application Data
(60) Provisional application No. 61/323,279, filed on Apr. 12, 2010.

(51) Int. Cl. F28F 1/10; B23P 15/26

(52) U.S. Cl. 165/181; 29/890.053

(57) ABSTRACT

Flattened tubes for use in heat exchangers and other systems and associated methods of manufacture and use are described herein. In one embodiment, for example, a method of manufacturing a flattened tube for use in a heat exchanger includes forming a plurality of generally parallel ridges on an internal surface of a generally round tube. The tube can be radially compressed into a generally oblong cross-sectional shape. Individual ridges can be spot welded together at contact points to form a plurality of fluid channels. The ridges can be formed in a generally helical path on the internal surface of the tube. Selected ridges can extend further from the internal surface than other ridges.

### CROSS-REFERENCE TO RELATED APPLICATIONS

The present application claims priority to U.S. Provisional Application Ser. No. 61/323,279, titled FLATTENED TUBES FOR USE IN HEAT EXCHANGERS AND OTHER SYSTEMS, AND ASSOCIATED METHODS OF MANUFACTURE AND USE, which was filed Apr. 12, 2010 and is incorporated herein by reference in its entirety.

### TECHNICAL FIELD

The following disclosure relates generally to tubes that are at least partially flattened, such as flattened copper tubes and, more particularly, to flattened tubes having internal channels with attached contact points.

### BACKGROUND

Copper tubing has many uses in heating, ventilation, air conditioning (HVAC), and other heat transfer applications. Round copper or brass tube, for example, is often used for condenser and evaporator coils in heat exchangers. Flattened copper or alloy tubing is often used in radiator applications. In these applications, individual lengths of flattened copper tube are typically positioned between alternating rows of fin stock. When the flattened copper tube is pressurized (with, for example, a refrigerant such as R410a), it causes the tube to ovalize and distort, pressing against the adjacent fins. This can create distortion in the fins which can impede airflow through the heat exchanger coil and reduce heat transfer performance. Heavier fin stock can be used to reduce tube distortion, but the heavier fin stock results in a greater air pressure drop through the fins, which reduces performance and increases cost. Moreover, as the flattened copper tube expands and contracts during operation cycles, premature tube failure may occur due to metal fatigue.

Various attempts have been made to reduce tube distortion by brazing the inner surfaces of the tube together at discrete locations. U.S. Pat. No. 3,662,582, for example, discloses a flattened copper tube having a plurality of internal fins. A piece of double-sided brazing material is inserted into the tube between the fins, and heat is applied to melt the brazing material and attach the tips of the internal fins together in certain locations. U.S. Pat. No. 5,586,598 discloses an aluminum tube having brazing material clad on the internal fin tips which is brazed after the tube is flattened. One of the disadvantages associated with both of these approaches is that the brazing material and the associated labor and capital equipment adds cost to the flattened tube. The information disclosed in U.S. Pat. Nos. 3,662,582 and 5,586,598 is incorporated herein in its entirety by reference.

Flat aluminum tubes for use in heat exchangers also exist. This type of tube, commonly referred to as “microchannel tube,” is typically an extruded tube with several parallel ports or channels. The disadvantage of microchannel aluminum tubing, however, is that the internal channels are parallel to the longitudinal axis of the tube. This prevents the refrigerant from circulating around the interior of the tube during use. As a result, the channels closest to the leading edge of the microchannel tube tend to dry out. The microchannel configuration also restricts refrigerant distribution between channels at the entry end of the tube. Both of these factors can limit the performance of the heat exchanger.

### BRIEF DESCRIPTION OF THE DRAWINGS

FIG. 1 is an isometric view of a round tube having a plurality of internal fins configured in accordance with an embodiment of the disclosure.

FIG. 2A is an end view of the copper tube of FIG. 1 after it has been flattened in accordance with an embodiment of the disclosure, and FIG. 2B is an enlarged end view of a portion of the flattened tube taken from FIG. 2A.

FIG. 3A is a top view of the flattened tube of FIG. 2A illustrating the cross-paths of the internal fins and the contact points thereof, FIG. 3B is a cross-sectional end view of the flattened tube taken substantially along line 3B-3B in FIG. 3A and illustrating the contact points of the taller fins, and FIG. 3C is an enlarged isometric view of a portion of the flattened tube.

FIGS. 4A-4C are partially schematic elevation views of heat exchangers using flattened copper tubes configured in accordance with embodiments of the present disclosure.

FIGS. 5A and 5B are partially schematic elevation views of two other heat exchangers using flattened copper tubes configured in accordance with additional embodiments of the present disclosure.

FIG. 6 is an isometric view illustrating a method of joining a plurality of flattened copper tubes to exterior fin stock for use in a heat exchanger in accordance with an embodiment of the disclosure.

FIGS. 7A-7C are a series of views illustrating various types of return bends for connecting flattened copper tubes together in accordance with the present disclosure.

FIG. 8A is a top view of a flattened tube illustrating paths of internal fins and the contact points thereof; FIG. 8B is a cross-sectional end view of the flattened tube taken substantially along line 8B-8B in FIG. 8A and illustrating contact points of the taller fins.

### DETAILED DESCRIPTION

The present disclosure describes various embodiments of flattened tubes, such as flattened copper tubes having interior surfaces with a plurality of cross-channels that are attached at selected points to provide the tube with sufficient strength to substantially maintain its shape at HVAC refrigerant operating pressures. In one embodiment, for example, a flattened tube can be manufactured by first producing a round copper tube having a plurality of inwardly-extending ridges or fins that describe a helical path around the interior surface of the tube. The internal fins can include a plurality of short fins and a plurality of tall fins at selected intervals and/or spacings. For example, in one embodiment a copper tube configured in accordance with the present disclosure can include a repeating pattern of four short fins, one tall fin, four more short fins, another tall fin, etc. After the internal fins have been formed, the tube is flattened to produce an oblong or oval cross section in which the tips of the opposing tall fins contact each other at cross-over points. The contact points form a pattern that can be varied based on the helix angle of the fins, the number of tall fins, and the fin spacing around the interior surface of the tube.

In one aspect of the present disclosure, the internal contact points of the tall fins can be spot welded together without the use of a cladding and/or brazing material. For example, the internal fins of the present disclosure can be spot welded together at selected locations using various resistance welding techniques, induction welding techniques, high frequency welding techniques, friction welding techniques, and/or other welding techniques in which the energy for the welding operation is applied to the outer surface of the flattened tube, and is transferred through the tube wall and the points of contact on the inner surface. As described in greater detail below, spot welding or otherwise attaching the contact points of the high fins together provides the tube with substantial strength that can resist substantial distortion at relatively high operating pressures. In addition, the pattern and spacing of the spot welded points can provide for controlled expansion into external fins to provide effective mechanical bonding for purposes of heat transfer without excessive distortion of the external fins. By welding together fins that are bare of cladding and/or brazing material, manufacturing and material costs can be reduced. These and other aspects of the present disclosure are described in greater detail below.

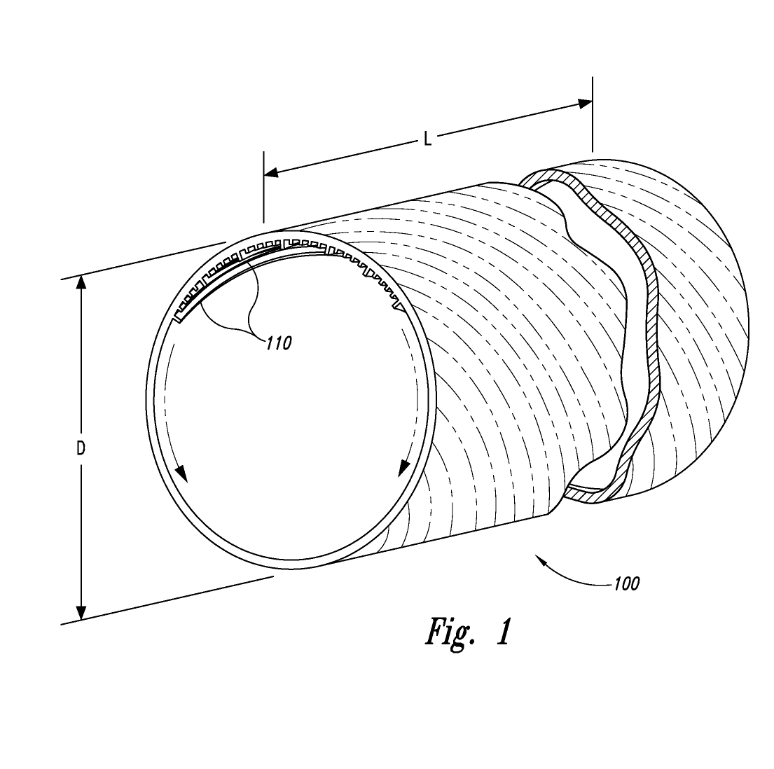

Certain details are set forth in the following description and in FIGS. 1-7C to provide a thorough understanding of various embodiments of the disclosure. Other details describing well-known structures and systems often associated with the manufacturing and use of copper tubes, flattened copper tubes, heat exchangers, etc., have not been set forth in the following disclosure to avoid unnecessarily obscuring the description of the various embodiments.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a partially cutaway isometric view of a round tube 100, such as a copper tube, having a plurality of internal ribs or fins 110 configured in accordance with an embodiment of the disclosure. In one aspect of this embodiment, the fins 110 extend in a helical path around the inside of the tube 100. Although only a portion of the fins 110 are illustrated in FIG. 1 for ease of illustration, in this embodiment the fins 110 cover the entire interior surface of the tube 100. As described in greater detail below, the fins can include high fins and/or low fins spaced apart around the inner circumference of the tube 100. In other embodiments, other types of fins and/or spacing can be used.

The finned tube 100 can be manufactured using various techniques. In one embodiment, for example, a seamless tube can be formed from a base metal, such as copper, and the fins 110 can be formed on the interior surface of the tube 100 by a grooving machine. In another embodiment, the tube and fins can be extruded directly from a billet of base metal, such as aluminum. In still another embodiment, the tube 100 can be manufactured by transferring a pattern of fins onto one side of a flat strip of material, such as metal, by rolling or otherwise embossing the fin pattern onto the material. The patterned strip can then be rolled and welded or otherwise joined in a cylindrical shape so that the fin pattern is on the interior surface. In some embodiments, for example, the edges of the patterned strip can be joined with a single longitudinal weld line to form the cylindrical tube 100.

The tube 100 can be provided in various sizes in accordance with the present disclosure depending on the desired application. In one embodiment, for example, the tube 100 can have an outer diameter D of from about 0.19 inch to about 2 inches, or about 0.5 inch. Moreover, the tube 100 can be provided in various stock lengths L of from about one foot to about 12 feet, or about 10 feet, or in a coil of several thousand feet. As those of the ordinary skill in the art will appreciate, flattened tubes configured in accordance with the present disclosure can be provided in a wide variety of diameters and lengths without departing from the spirit or scope of the present disclosure. The tube 100 can additionally be provided in various materials, including both ferrous and non-ferrous metals. In some embodiments, for example, the tube 100 can be provided in copper, copper alloys such as brass, plastic, steel, steel alloys such as stainless steel, as well as other suitable materials known in the art.

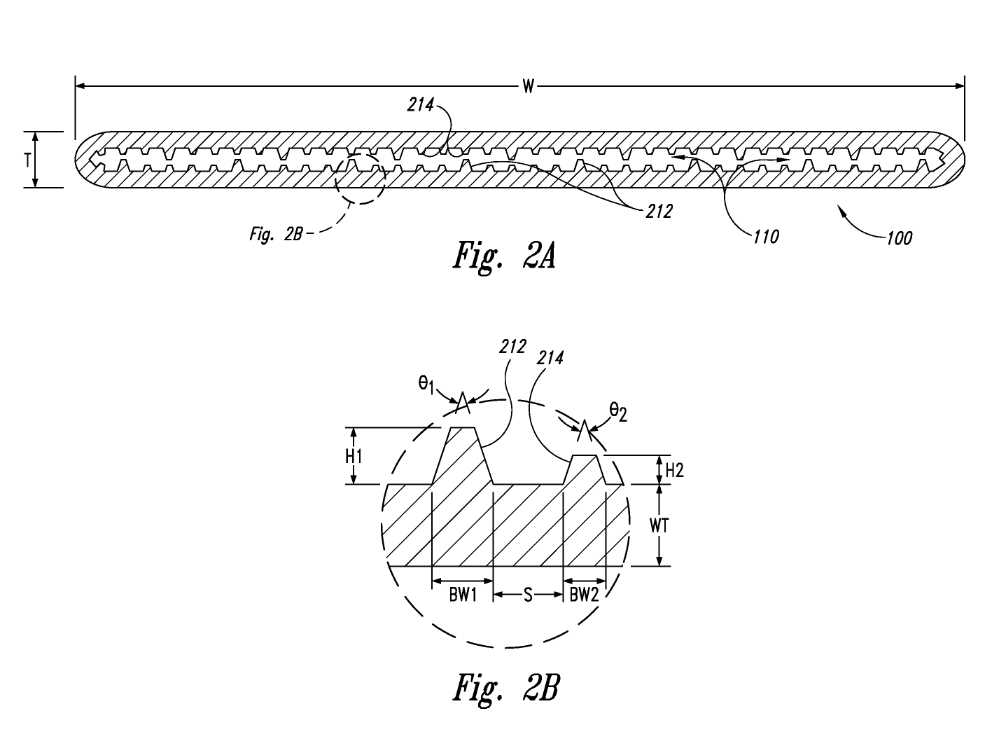

FIG. 2A is an enlarged end view of the tube 100 after it has been flattened in accordance with the present disclosure, and FIG. 2B is an enlarged end view of a portion of the flattened tube 100 taken from FIG. 2A. Referring first to FIG. 2A, in the illustrated embodiment the tube 100 has been flattened into an oblong or oval cross-section having a cross-sectional thickness T and a width W across the flattened side portions. The thickness T can be from about 0.02 inch to about 0.25 inch, or about 0.060 inch. The width W can be from about 0.25 inch to about 3 inches, or about 0.71 inch. As those of ordinary skill in the art will appreciate, the foregoing dimensions of the flattened tube 100 are merely illustrative of various embodiments. Accordingly, other embodiments of the present disclosure can include flattened tubes having different widths, thicknesses, shapes, spot weld patterns, etc. depending on the particular application of use and/or a number of different variables including, for example, the wall thickness of the tube, the outer diameter of the tube, the amount of flattening, etc. Therefore, those of ordinary skill in the art will appreciate that various embodiments of the invention described herein are not necessarily limited to any particular tube configuration, but extend to all such configurations falling within the scope of the claims.

In the illustrated embodiment, the internal fins 110 include a plurality of first fins 212 and a plurality of shorter, second fins 214. For ease of reference, the first fins 212 will be referred to herein as “the tall fins 212,” and the second fins 214 will be referred to as “the short fins 214.” The terms “tall” and “short” are of course relative, and simply indicate that the tall fins 212 are taller than the short fins 214. In some embodiments, the tall fins 212 and the short fins 214 can be evenly spaced around the interior surface of the tube 100 in various patterns. In the illustrated embodiment, for example, the tube 100 includes a repeating pattern of one tall fin 212, four short fins 214, another tall fin 212, four more short fins 214, etc. As described above with reference to FIG. 1, the fins 212 and 214 define helical grooves or channels around the inside of the tube 100 prior to flattening. Once flattened, however, the fins extend diagonally across the interior surface of the tube 100, as described in greater detail below. In other embodiments, flattened tubes configured in accordance with the present disclosure can include other fin patterns and fin spacing. For example, in some embodiments, the tall fins 212 and the short fins 214 are not evenly spaced around the interior surface of the tube 100, but are instead selectively spaced to alter the mechanical strength and/or heat transfer properties of the tube 100. Selective spacing of the fins 212, 214 can additionally alter fin contact patterns, as discussed in further detail below.

Referring next to FIG. 2B, each of the tall fins 212 has a first height H1, and each of the short fins 214 has a second height H2. The first height H1 can be from about 0.010 inch to about 0.030 inch, or about 0.018 inch. The second height H2 can be from about 0.00001 inch to about 0.012 inch, or about 0.005 inch. Moreover, each of the tall fins 212 can include a first base width BW1 and a first apex angle θ₁, and each of the short fins 214 can include a second base width BW2 and a second apex angle θ₂. In the illustrated embodiment, the first base width BW1 can be from about 0.010 inch to about 0.075 inch, or about 0.026 inch, and the first apex angle θ₁ can be from about 10° to about 120°, or about 60°. The second base width BW2 can be from about 0.002 inch to about 0.020 inch, or about 0.015 inch, and the second apex angle θ₂ can be from about 10° to about 120°, or about 45°. The tall fins 212 and the short fins 214 can be spaced apart from each other by a distance S. The distance S can be from about 0.005 inch to about 0.03 inch, or about 0.012 inch. As mentioned above, in some embodiments, the spacing S between the fins 212, 214 is not constant around interior surface of the tube 100, and the tube 100 need not include both tall fins 212 and short fins 214. In addition to the foregoing dimensions, the tube 100 can have a wall thickness WT of from about 0.008 inch to about 0.04 inch, or about 0.014 inch. As those of ordinary skill in the art will appreciate, the foregoing dimensions of the tall fins 212, the short fins 214, and/or the tube 100 are merely illustrative of particular embodiments of the present disclosure. Accordingly, other embodiments of flattened tubes having internal ribs, fins, grooves, channels, etc. configured in accordance with the present disclosure can have other dimensions depending on various factors, such as the particular application, the method of manufacture, etc.

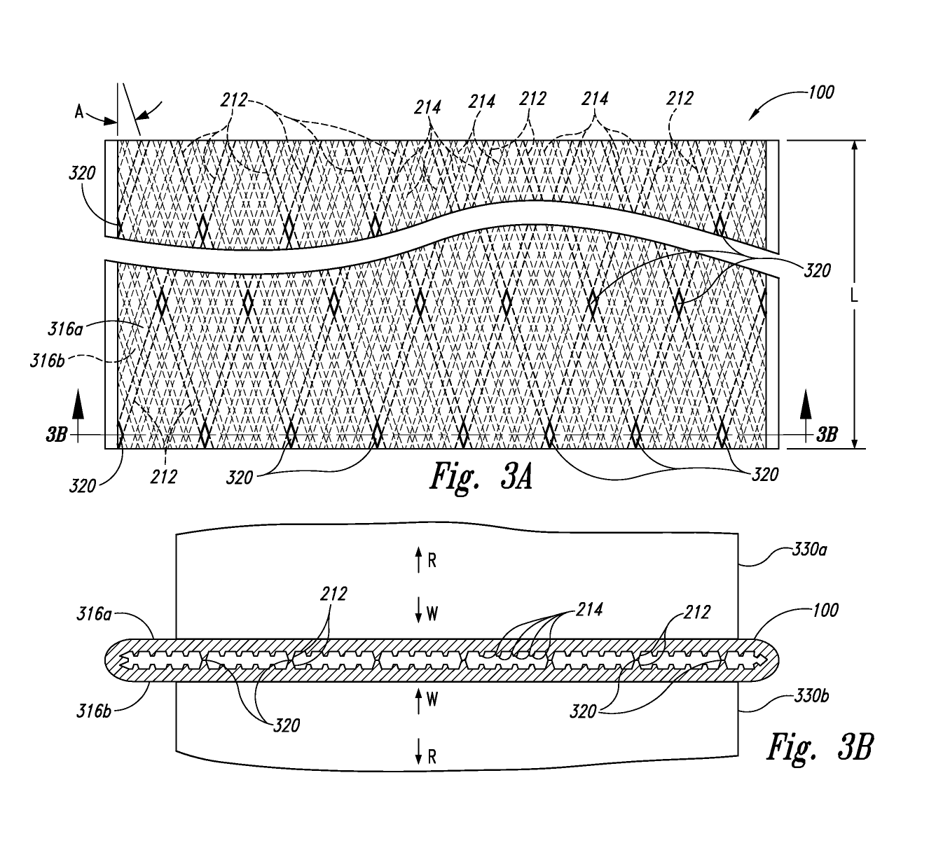

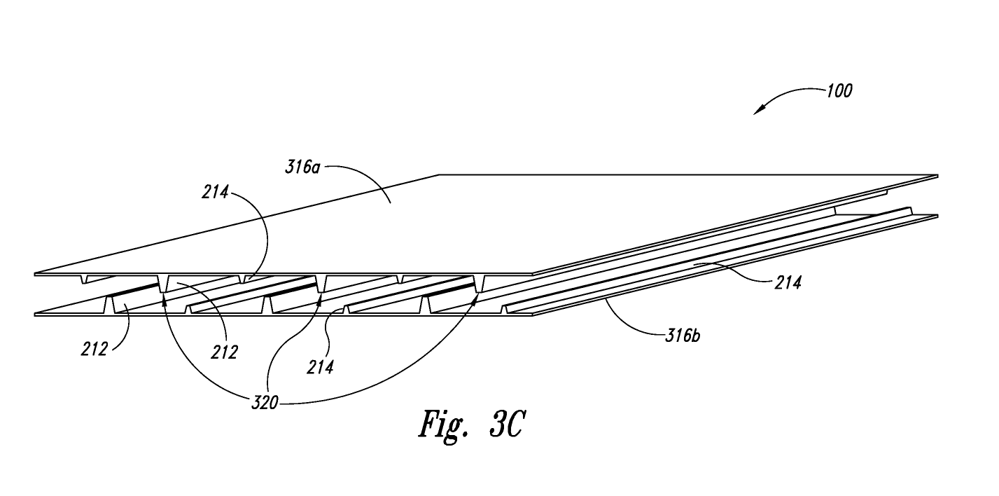

FIG. 3A is a top or plan view of the flattened tube 100, FIG. 3B is a cross-sectional end view of a portion of the flattened tube 100 during a spot welding process, and FIG. 3C is an enlarged isometric view of a portion of the flattened tube 100 illustrating spot weld locations. Referring first to FIG. 3A, as this view illustrates the tall fins 212 and the adjacent short fins 214 extending along relatively straight, overlapping or crisscrossing diagonal paths after the tube 100 has been flattened. For example, the fins 212 and 214 can extend at a helix angle A of from about 5 degrees to about 60 degrees, or about 10 degrees to about 45 degrees, or about 30 degrees relative to a longitudinal axis of the flattened tube 100. In still other embodiments, as discussed further below with reference to FIGS. 8A and 8B, the helix angle A can be zero degrees, and the fins 212, 214 can be parallel, or at least generally parallel, to the longitudinal axis of the tube 100.

Referring to FIGS. 3A and 3B together, the flattened tube 100 includes a first sidewall portion 316a and an opposite second sidewall portion 316b. The tip portions of the tall fins 212 on the interior surface of the first sidewall portion 316a contact the tip portions of the tall fins 212 on the opposite interior surface of the second sidewall portion 316b at a plurality of contact points 320. In the illustrated embodiment, the rows of contact points 320 are evenly spaced in both the longitudinal and transverse directions of the flattened tube 100. Accordingly, the short fins 214 which extend between the contact points 320 do not contact each other and instead describe crisscrossing diagonal pathways or channels that refrigerant or other pressurized fluids can circulate through during use of the flattened tube 100. The cross-channel internal structure of the tube 100 allows refrigerant to circulate through the open pathways and move to the respective leading edges of the flattened tube to reduce the tendency for the refrigerant to dry out in these regions, as is typically experienced with conventional flattened tubes having longitudinal and/or isolated channels.

As shown in FIG. 3B, the contact points 320 of the tall fins 212 can be attached using, for example, a spot welding machine having a first tool portion 330a and a second tool portion 330b. In the illustrated embodiment, the first tool portion 330a can be a first electrode and the second tool portion 330b can be an opposing second electrode. In operation, the opposing tool portions 330 are moved away from each other in direction R, and the tube 100 is positioned between the opposing tool portions 330. The tool portions 330 are then moved back toward each other in direction W to clamp the sidewall portions 316 together and introduce a concentrated welding current that passes through the touching tip portions of the tall fins 212 and melts or otherwise fuses the metal together at the contact points 320. After the tall fins 212 have been welded together at the contact points 320, the tool portions 330 move apart in the direction R and release the flattened tube 100. The next section of the tube 100 can then be positioned between the tool portions 330 and welded together in the manner described above.

In other embodiments, the tool portions 330 can be opposing rollers that clamp the sidewall portions 316 together and weld the contact points 320 together in a continuous operation. In such embodiments, the tool portions 330 can roll on parallel axes that extend perpendicularly relative to the longitudinal axis of the flattened tube 100, and apply welding current to the portion of the tube 100 between the rollers. In some embodiments, the spot welding can be done “in-line” with the flattening operation. That is, the tube 100 can be flattened and the contact points 320 welded together at the same time by rollers that apply a controlled weld current to the tube 100 as they flatten the tube. This approach to the flattening/welding process enables it to be a “continuous” process, rather than a “batch.” In other embodiments, other types of welding machines having other types of tools, electrodes, etc. can be used to join or attach the tall fins 212 together at the contact points 320. Moreover, such machines can use other spot welding techniques, such as high frequency welding, induction welding, resistance welding, friction welding, etc., and can be used to locally join or attach the opposing tall fins 212 together. Regardless of the particular welding machine or technique used, in the foregoing embodiments the tall fins 212 can be welded together in controlled patterns so that only selected fin tips are welded rather than all fin tips. Moreover, although one spot weld pattern is illustrated in, for example, FIG. 3A, in other embodiments other spot weld patterns can be used. Such other patterns may be dictated by, for example, the particular application of use, operating pressure and/or temperature, cost, and/or other practical considerations.

In some embodiments, the internal contact points 320 of the tall fins 212 can be spot welded together without the use of a cladding and/or brazing material on the fins 212 and/or the fin tips. For example, in some embodiments, the tube 100 and the fins 212 can be formed from a base material, such as copper. When the tube 100 is flattened, opposing surfaces of the base material contact each other at the contact points 320 in the absence of a cladding and/or brazing material on or between the contacting surfaces of the fins 212. By welding together fins tips that do not require cladding and/or brazing material, manufacturing and material costs can be reduced.

As shown in FIG. 3C, the angular orientation of the opposing fins 212 and 214 results in discrete contact points between the tall fins 212 occurring at pre-selected intervals within the flattened tube 100. Moreover, as this view illustrates, the fins 212 and 214 form open cross channels in the opposing interior surfaces of the flattened tube 100 that extend crossways relative to each other and tend to circulate refrigerant throughout the tube 100 during use, thereby enhancing thermal efficiency and performance.

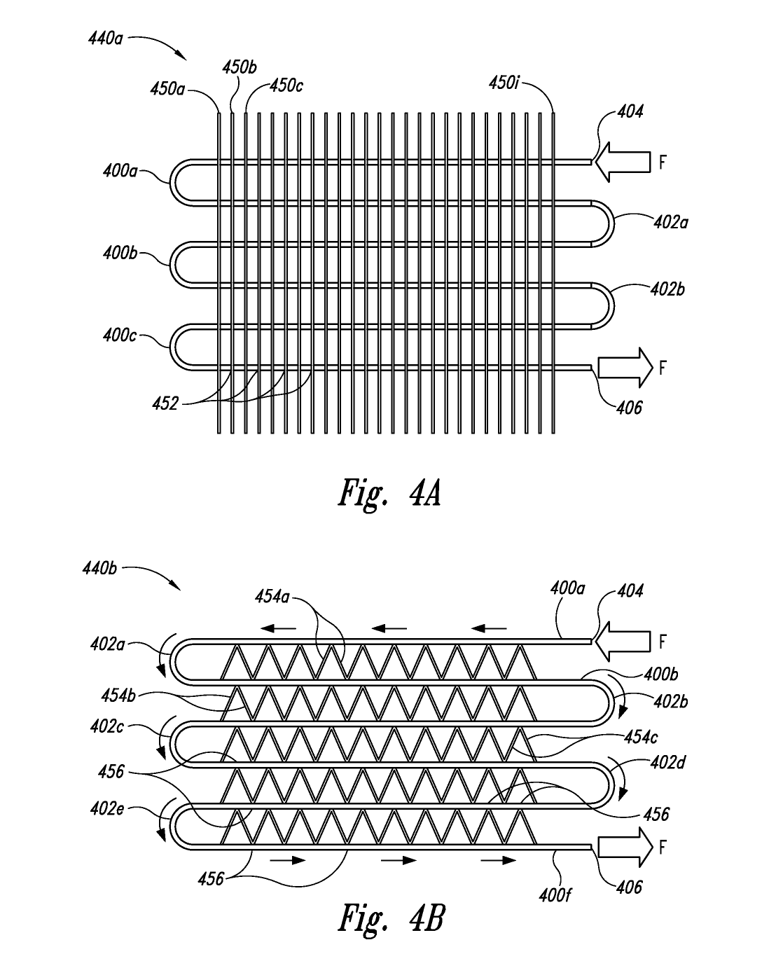

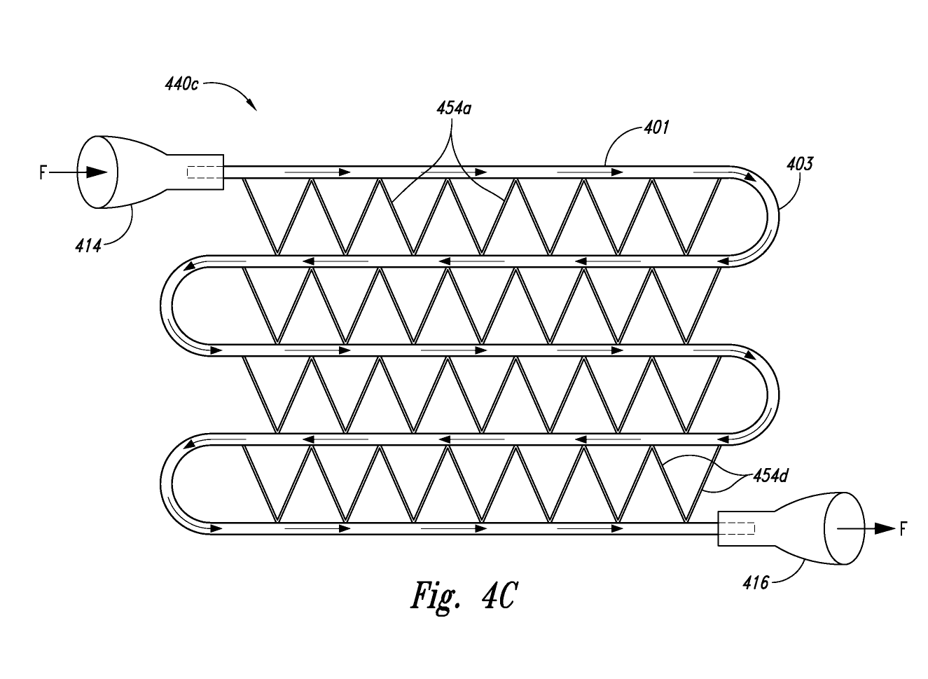

FIGS. 4A-4C are a series of plan views of a first heat exchanger 440a, a second heat exchanger 440b, and a third heat exchanger 440c, respectively, that include flattened copper tubes configured in accordance with the present disclosure. Referring first to FIG. 4A, the first heat exchanger 440a is a plate fin type heat exchanger having a plurality of flattened copper tube sections 400 (identified individually as flattened tubes 400a-c) extending transversely across a plurality of spaced-apart fins 450 (e.g., plate fins). The flattened tubes 400 can be at least generally similar in structure and function to the flattened tube 100 described in detail above. In the illustrated embodiment, however, the individual tube sections 400 have elongated U-shapes (and can be referred to as “hair pins”) that extend across the fins 450. The end portions of adjacent tubes 400 can be operably connected together in fluid communication with a suitable return tube, or return bend, 402 (identified individually as return tubes 402a and 402b) to form a continuous fluid conduit that winds back and forth through the plate fins 450. As described in greater detail below, various types of return bends can be used for this purpose and the return bends 402 can be coupled to the tubes 400 by various techniques, such as brazing. The fins 450 can be formed from thin metal plate stock, such as aluminum alloy or copper alloy. Each of the fins 450 includes a plurality of aligned apertures or openings 452 through which the flattened tubes 400 extend.

In one aspect of the present disclosure, the flattened tubes 400 can be mechanically, hydraulically, and/or pneumatically expanded so that they open up slightly against the apertures 452 to secure the tubes 400 to the plate fins 450. For example, when the tubes 400 are pressurized with fluid they will expand slightly in the areas between the spot welds/contact points 320 (see FIGS. 3A and 3B) in proportion to the applied pressure. This “controlled expansion” of the tubes 400 can provide a means for beneficially maintaining thermal contact between the tubes 400 and the fins 450 without having to braze the fins 450 to the tubes 400. In a further aspect of the present disclosure, this expansion can be controlled by selective spacing of the spot-welded fin contact points 320 (e.g., tighter spacing—less expansion, looser spacing—more expansion), by adjusting the flattened tube 400 wall thickness WT (see, for example, wall thickness WT in FIG. 2B) (e.g., thinner wall—more expansion, thicker wall—less expansion), by selective annealing of the tube 400 after the welding process, and/or by selective use of internal pressure. The spot weld spacing can be varied by varying the locations or number of the contact points, by altering the helix angle, or by only welding selected contact points. Alternatively, in other embodiments the plate fins 450 could be soldered, brazed, bonded, or otherwise attached to the flattened tubes 400.

In operation, working fluid F flows into the first flattened tube 400a via an inlet 404. As the working fluid flows through the first flattened tube 400a, the first return tube 402a, and then into the second flattened tube 400b, etc., the working fluid F (e.g., pressurized refrigerant R410a, etc.) can absorb heat from (or transfers heat to) the airflow (not shown) passing through the plate fins 450. After circulating through each of the flattened tubes 400, the working fluid F exits the first heat exchanger 440a via an outlet 406. As discussed above, the expansion of the tubes 400 under operating pressure can be controlled by proper selection of the number, location, pattern, etc. of the welded contact points of the tall internal fins 212 (FIGS. 2A-3B). By controlling expansion of the flattened tubes 400, a desired level of mechanical interference can be provided between the tubes 400 and the exterior fins 450 to affect a desired level of heat transfer and prevent an excessive amount of tube ovalization, which can create undesirable distortion of the fins 450 and negatively impact heat transfer performance of the coil.

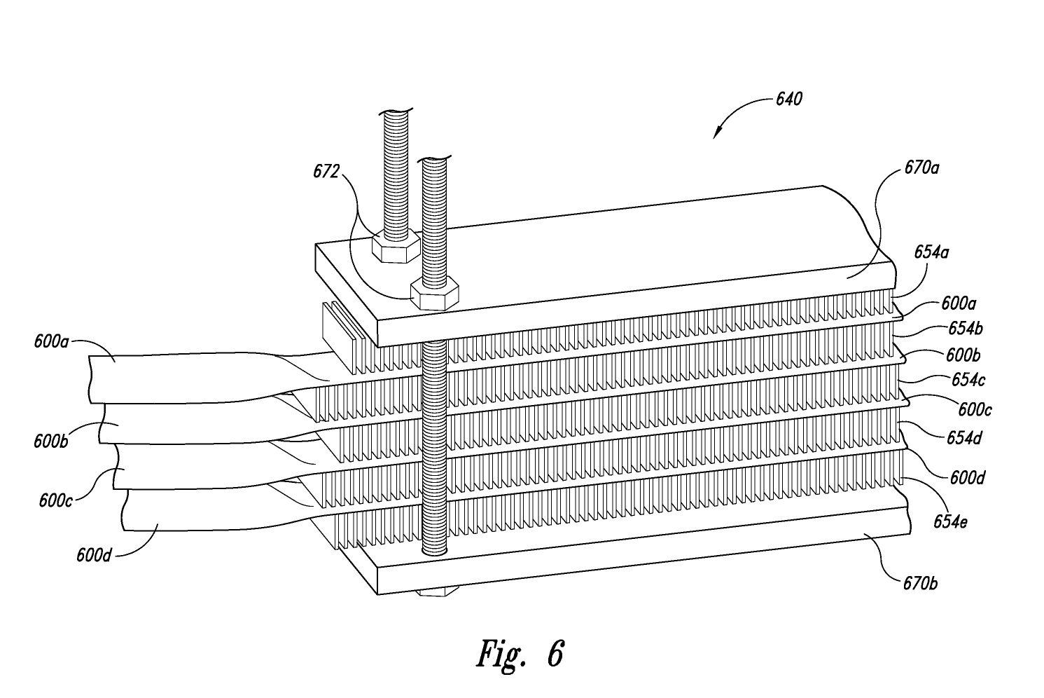

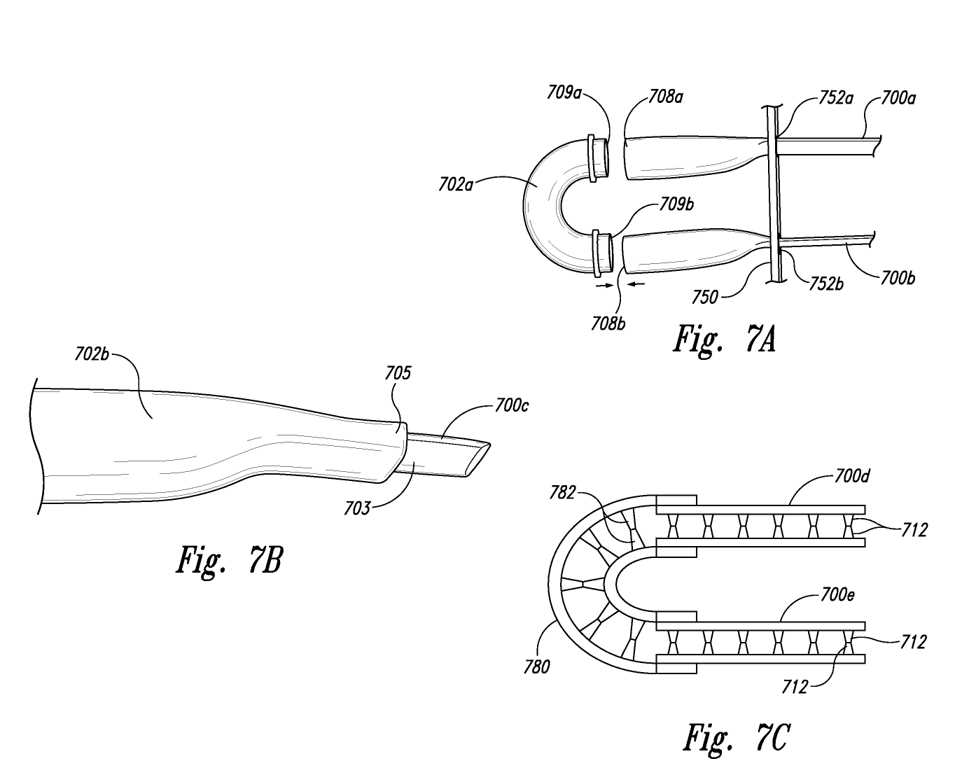

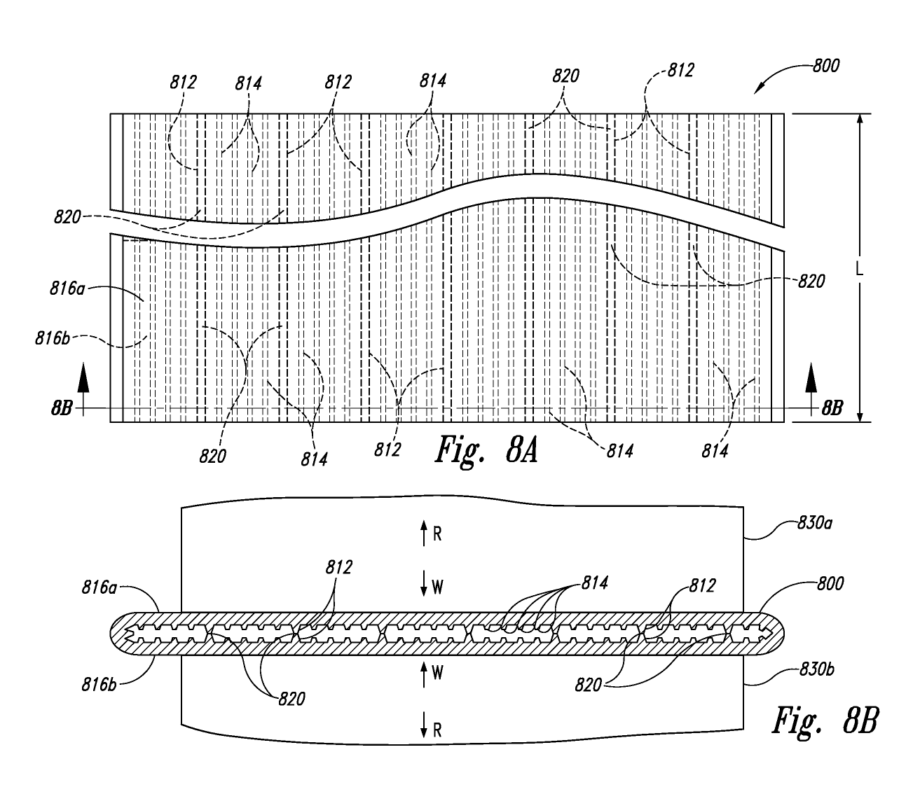

Referring next to FIG. 4B, in the illustrated embodiment many features of the second heat exchanger 440b can be at least generally similar in structure and function to corresponding features of the first heat exchanger 440a described in detail above. In the embodiment of FIG. 4B, however, the second heat exchanger 440b is a folded fin (also referred to as a “ribbon fin” or “serpentine fin”) type heat exchanger having a plurality of serpentine fin portions 454a-e positioned between the flattened tubes 400. As described below with reference to FIG. 6, the alternating arrangement of the tubes 400 and the fin portions 454 can be sandwiched and/or pressed together and joined using brazing, soldering, adhesive bonding, mechanical clamping, and/or other suitable techniques known in the art. In operation, working fluid F flows into the first tube portion 400a via the inlet 404 and circulates through each of the respective tube portions 400 before exiting the second heat exchanger 440b via the outlet 406.

Referring next to FIG. 4C, many features of the third heat exchanger 440c can be at least generally similar in structure and function to corresponding features of the second heat exchanger 440b described in detail above. In the embodiment of FIG. 4C, however, the third heat exchanger 440c includes a single flattened tube 401 having a series of bends 403 in serpentine fashion with a plurality of fin portions 454a-d positioned between the tube rows. The tube 401 can be at least generally similar in structure and function to the flattened tube 100 described above, and can be annealed prior to bending to facilitate forming the bends 403. Moreover, the welded tips of the tall fins 212 (FIGS. 2A-3B) may provide internal support for the tube 401 and resist twisting, bending, and kinking while maintaining open flow channels. In some embodiments, the heat exchanger 440c can further include a first end fitting 414 (e.g., an inlet) and/or a second end fitting 416 (e.g., an outlet) that transition from the flattened cross-section of the tube 401 to a round cross-section for connection to a round inlet/outlet tube (not shown). In other embodiments, the end portions of the tube 401 can be flared to a round cross-sectional shape to mate with a correspondingly round connecting tube.

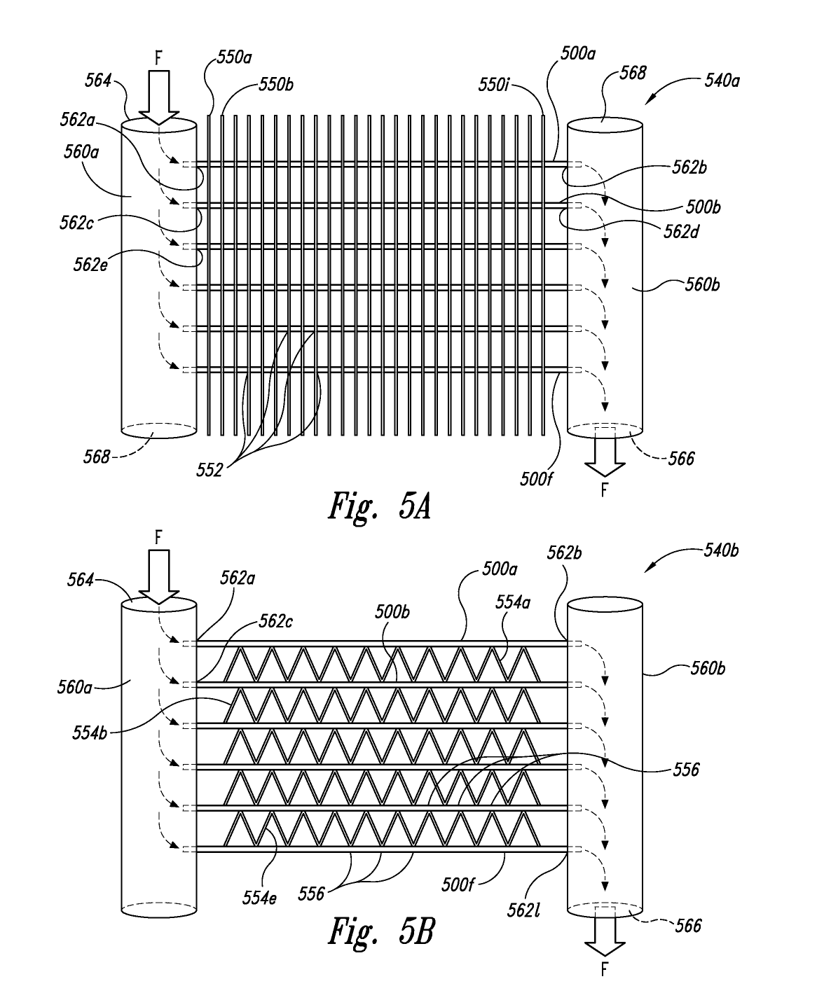

FIGS. 5A and 5B are plan views of a fourth heat exchanger 540a and a fifth heat exchanger 540b that can also use flattened tubes configured in accordance with the present disclosure. In the illustrated embodiments, however, the fourth and fifth heat exchangers 540a, b differ from the heat exchangers described above in that opposing header tubes 560 are used to introduce working fluid F to flattened copper tubes 500a-f and transfer the working fluid F away from the heat exchanger.

As shown in FIG. 5A, for example, the first header 560a is constructed of a hollow tube having a working fluid inlet 564 at one end portion thereof and a plug 568 at the opposite end portion. The second header 560b is similarly constructed of a hollow tube having a plug 568 at one end portion thereof and an outlet 566 at the opposite end portion. Each of the headers 560 can also include a series of openings or apertures 562 configured to receive opposing end portions of the individual flattened tubes 500. In one aspect of this embodiment, a plurality of flat plate fins 550 that are at least generally similar in structure and function to the flat plate fins 450 described above extend parallel to the headers 560 and transverse to the flattened tubes 500 between the opposing headers 560. Each of the fins 550 includes a plurality of aligned apertures or openings 552 through which the flattened tubes 500 extend. All or portions of the flattened tubes 500 can be controllably expanded to achieve a desired level of physical interference between the tubes 500 and the fins 550. In operation, the working fluid F enters the fourth heat exchanger 540a via the inlet 564, and flows from the first header 560a into the open end portions of the individual flattened tubes 500. The working fluid F flows across the flattened tubes 500 transferring heat with the surrounding air flow, and then into the receiving header 560d before exiting via the outlet 566. In other embodiments, one or both of the headers 560 can include one or more baffles and/or other suitable devices known in the art for directing or otherwise recirculating the working fluid F in different flow paths through the various flattened tubes 500.

Referring next to FIG. 5B, this view illustrates yet another embodiment of a heat exchanger configured in accordance with the present disclosure. In this embodiment, the fifth heat exchanger 540b includes serpentine or ribbon type fin portions 554 attached to the adjacent flattened tubes 500 between the opposing headers 560. Other than the particular cooling fin arrangement, the other structural and functional aspects of the fifth heat exchanger 540b can be at least generally similar to the corresponding aspects of the fourth heat exchanger 540a described in detail above with reference to FIG. 5A.

FIG. 6 is an isometric view illustrating one method of joining a plurality of flattened tubes 600a-d configured in accordance with the present disclosure to adjacent cooling fin portions 654a-d. In the illustrated embodiment, the fin portions 654 are comprised of serpentine or corrugated ribbon-type aluminum cooling fins that are compressed between the alternating tubes 600 by opposing tool plates 670. The tool plates 670 can be temporarily clamped together using a plurality of suitable nut and bolt combinations 672 to achieve a desired level of compression for bonding, brazing, or otherwise attaching the cooling fin portions 654 to the flattened tubes 600.

As mentioned above with reference to FIGS. 4A and 4B, various types of return tubes can be used to join the adjacent flattened tube sections together for use in various types of heat exchanger assemblies. FIGS. 7A-7B are a series of views illustrating at least some of the various types of return tubes that can be used. Referring first to FIG. 7A, for example, in this embodiment a first flattened tube portion 700a has a first end portion 708a, and a second flattened tube portion 700b has a second end portion 708b. The first and second flattened tube portions 700 can be at least generally similar in structure and function to the flattened tube 100 described in detail above with reference to FIGS. 1-3C. The flattened tube portions 700 can extend through a plurality of complementing apertures 752 in a backing plate 750. In the illustrated embodiment, the apertures 752 can have shapes that are the same as, or at least approximately the same as, the cross-section of the flattened tube portion 700 so that the flattened tube portions 700 fit snugly in the apertures 752. The backing plate 750 and apertures 752 can serve as a framework which secures the positioning of the tube portions 700 relative to one another. In some embodiments, the contact points of the internal fins (not shown) near the end portions 708 are not welded together so that the end portions 708 can be expanded via, for example, internal pressure back to a round, or at least approximately round cross-section. In other embodiments, the contact points of the internal fins near the end portions 708 are welded together, but these welds are broken apart as the end portions 708 are expanded back to the generally round cross-sectional shape. This enables the round end portions 708 to be received by and joined to corresponding round end portions 709a, b of a return tube 702a. Once fit together, the respective end portions can be soldered or otherwise joined together using various suitable techniques known in the art.

In FIG. 7B, a flattened tube 700c configured in accordance with the present disclosure has a flattened end portion 703 which maintains the flattened tube cross section. In this embodiment, a return tube 702b also has a flattened end portion 705 that forms a collar configured to receive the corresponding end portion 703 of the flattened tube 700c.

Referring next to FIG. 7C, in this cross-sectional view a first flattened tube 700d is joined in fluid communication to a second flattened tube 700e via a return tube 780 that is also formed from a flattened tube. Accordingly, in this embodiment the flattened tubes 700 include spot-welded internal fins 712, and the return tube 780 similarly includes spot-welded internal fins 782. As with the flattened tube 100 described in detail above, the internal fins 712 and 782 extend along angular or helical paths within the flattened tubes 700 and the return tube 780, respectively, so that the working fluid circulates efficiently around the interior portions of the tubes during use.

FIG. 8A is a top or plan view of a flattened tube 800 having many features that are at least generally similar to those of flattened tube 100 described above with reference to FIGS. 1-3C. For example, the tube 800 includes a plurality of tall fins 812 and adjacent short fins 814 extending along an internal surface of the tube 800. In the illustrated embodiment, however, the fins 812 and 814 extend parallel to a longitudinal axis of the flattened tube 800 rather than in a helical path.

FIG. 8B is a cross-sectional end view of a portion of the flattened tube 800 during a spot welding process. Referring to FIGS. 8A and 8B together, the flattened tube 800 includes a first sidewall portion 816a and an opposite second sidewall portion 816b. In the illustrated embodiment, the tip portions of the tall fins 812 on the interior surface of the first sidewall portion 816a contact the tip portions of the adjacent tall fins 812 on the opposite surface of the second sidewall portion 816b at contact points 820 that extend the length of the tube 800. As shown in FIG. 8B, the tall fins 812 can be attached to opposing tall fins 812 using the methods and tools described above with reference to FIG. 3B. For example, the fins 812 can be attached using a spot welding machine having a first tool portion 830a and a second tool portion 830b. The first tool portion 830a can be a first electrode and the second tool portion 830b can be an opposing second electrode. In operation, the opposing tool portions 830 are moved away from each other in direction R, and the tube 100 is positioned between the opposing tool portions 830. The tool portions 830 are then moved back toward each other in direction W to clamp the sidewall portions 816 together and introduce a concentrated welding current that passes through the tip portions of the tall fins 812 and melts or otherwise fuses the metal together at the contact points 820. After the tall fins 812 have been welded to opposing tall fins 812, the tool portions 830 move apart in the direction R and release the flattened tube 800. The next section of the tube 800 can then be positioned between the tool portions 830 and welded together in the manner described above. In other embodiments, as described above with reference to FIG. 3B, the tool portions 830 can be opposing rollers that clamp the sidewall portions 816 together and weld the contact points 820 together in a continuous operation.

Although one spot weld pattern is illustrated in, for example, FIG. 8A, in other embodiments other spot weld patterns can be used. For example, while the rows of contact points 820 illustrated in FIG. 8A are evenly spaced apart, in other embodiments the contact points 820 can have other spacing patterns. In some embodiments, the contact points 820 do not extend the full longitudinal length L of the tube 800, but instead are located at preset intervals along the length of the tall fins 812. In still further embodiments, the tip portions of the tall fins 812 on the interior surface of the first sidewall portion 816a can contact the interior surface of the second sidewall portion 816b, and the tip portions of the tall fins 812 on the interior surface of the second sidewall portion 816b can contact the interior surface of the first sidewall portion 816a. As described above with reference to FIGS. 3A and 3B, in some embodiments, the tall fins 812 can be spot welded without the use of a cladding and/or brazing material on the fins 812 and/or the fin tips.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/we claim:

1. A method of manufacturing a flattened tube for use in a heat exchanger, the method comprising:
forming a plurality of ridges on an interior surface of a tube having a generally round cross-sectional shape, wherein the tube is formed from a base material, and wherein the ridges are formed from the base material;
flattening the tube into a generally oblong cross-sectional shape; and
welding the base material of individual ridges together at contact points.

2. The method of claim 1 wherein forming the plurality of ridges comprises forming ridges in a generally helical path on the interior surface of the tube.

3. The method of claim 1 wherein the flattened tube has a longitudinal axis, and wherein forming the plurality of ridges comprises forming ridges parallel to the longitudinal axis on the interior surface of the tube.

4. The method of claim 1 wherein forming the plurality of ridges comprises forming selected ridges that extend further from the interior surface than other ridges.

5. The method of claim 1 wherein:
forming a plurality of ridges comprises forming ridges from copper; and
welding the base material of individual ridges together comprises welding contacting copper surfaces together.

6. The method of claim 1 wherein welding the base material of individual ridges comprises welding in the absence of a cladding or brazing material on the ridges.

7. The method of claim 1 wherein welding the base material of individual ridges comprises forming a plurality of flow paths that cross at an angle.

8. The method of claim 1 wherein welding the base material of individual ridges comprises positioning the tube between a first electrode and a second opposing electrode to introduce a current that passes through the contact points.

9. The method of claim 1 wherein forming the plurality of ridges on the interior surface of the tube comprises forming a seamless tube and forming ridges into the interior surface of the tube.

10. The method of claim 1 wherein forming the plurality of ridges on the interior surface of the tube comprises:
forming ridges on a first side of a sheet of material, the sheet having a first edge and a second edge opposite the first edge;
rolling the sheet into a generally cylindrical tube; and
welding the first and second edges of the sheet together.

11. The method of claim 1 wherein forming ridges on the tube comprises forming ridges on a copper tube.

12. A method of manufacturing a heat exchanger, the method comprising:
forming a plurality of ridges on an internal surface of a generally round tube,
wherein:
the individual ridges have corresponding tip portions;
the tube comprises a first end portion, a second end portion, and a middle portion positioned between the first end portion and the second end portion; and
the individual ridges and the tube are formed from a base material;
flattening the middle portion of the tube;
welding the base material of contacting tip portions together; and
coupling the first end portion to a generally round end fitting.

13. The method of claim 12 wherein the end fitting is a first end fitting, and wherein the method further comprises coupling the second end portion to a generally round second end fitting.

14. The method of claim 12 wherein the tube is a first tube, and wherein the method further comprises:
flattening a second tube; and
positioning a plurality of fins between the first tube and the second tube.

15. The method of claim 12 wherein welding the base material of contacting tip portions comprises welding in the absence of a cladding or brazing material on the tip portions.

16. The method of claim 12 wherein:
forming a plurality of ridges comprises forming a plurality of ridges having copper tip portions; and
welding the base material of contacting tip portions comprises welding contacting copper surfaces of the tip portions.

17. The method of claim 12 wherein forming the plurality of ridges comprises forming a plurality of tall ridges and a plurality of short ridges.

18. The method of claim 12 wherein forming the plurality of ridges comprises forming a plurality of ridges in a generally helical path on the internal surface of the tube.

19. The method of claim 12, further comprising controllably expanding the flattened tube by use of mechanical, hydraulic, or pneumatic force.

20. The method of claim 19 wherein controllably expanding the flattened tube includes selectively controlling a spacing or pattern of the contacting tip portions.

21. The method of claim 19 wherein controllably expanding the flattened tube comprises annealing the tube after welding the tip portions.

22. The method of claim 12 wherein forming ridges on the internal surface of the tube comprises forming ridges on the internal surface of a copper tube.

23. A heat exchanger, comprising:
a flattened tube having an interior surface and an exterior surface; and
a plurality of fins positioned on the interior surface, the individual fins having a base portion and a tip portion, wherein:
the tip portions are bare of a cladding or brazing material;
at least some of the tip portions contact opposing tip portions; and
at least some of the contacting, opposing tip portions are welded together.

24. The heat exchanger of claim 23 wherein the fins extend in a generally diagonal path around the interior surface of the tube.

25. The heat exchanger of claim 23 wherein the plurality of fins includes tall fins and short fins, and wherein at least some of the welded fins comprise a first tall fin welded to a second tall fin.

26. The heat exchanger of claim 23 wherein the plurality of fins defines fluid channels that cross at an angle.

27. The heat exchanger of claim 23 wherein the flattened tube is at least partially made of copper, an alloy of copper, an alloy of aluminum, plastic, steel, or an alloy of steel.

28. The heat exchanger of claim 23 wherein the welded tip portions are evenly spaced along the interior surface of the tube.

29. The heat exchanger of claim 23 wherein the flattened tube comprises a first flattened tube having a first exterior surface and wherein the heat exchanger further comprises:
a second flattened tube having a second exterior surface; and
a plurality of fins positioned between the first exterior surface and the second exterior surface.

30. The heat exchanger of claim 23 wherein:
the flattened tube includes a first end, a second end opposite the first end, and a central portion between the first end and the second end;
the flattened tube is flattened in the central portion and has a generally round cross-sectional shape at the first end and the second end; and
the heat exchanger further comprises a return tube coupled to at least one of the first end or the second end.
